(19) United States
(12) Patent Application Publication
(10) Pub. No.: US 2008/0235681 A1
(43) Pub. Date: Sep. 25, 2008

(54) System, method and apparatus for retrieving schedule information from a remote location for an electronic calendar

(76) Inventor: Howard Barnett, Dallas, TX (US)

Correspondence Address: DOCKET CLERK, P.O. DRAWER 800889, DALLAS, TX, 75380, US

(21) Appl. No.: 12/070,723

(22) Filed: Feb. 20, 2008

Related U.S. Application Data
(60) Provisional application No. 60/902,236, filed on Feb. 20, 2007.

(51) Int. Cl. G06F 9/445; G06F 15/16; G06F 17/00

(52) U.S. Cl. 717/178; 709/203; 715/205

(57) ABSTRACT

A user device accesses a webpage (hosted on a schedule host server) to identify a calendar or schedule of interest for downloading for incorporation into a calendar application within the user device (or otherwise identifies the calendar or schedule from a message received at the user device). A single click on a link within the webpage or message) selects a specific schedule or events or calendar entries corresponding thereto and constitutes a user request for the information. The user's request is redirected to a fulfillment server that retrieves calendar/schedule information corresponding to the selected link and downloads the information to the user's calendar, and thus multiple calendar entries are inserted and stored in response to selection of the link. A calendar plug-in may be provided within the user device for interfacing to the calendar application. Optionally, additional information (i.e., markers, tags, flags) may be inserted or associated with the calendar entries to uniquely identify them and associate them with a specific calendar/schedule.

### CROSS-REFERENCE TO RELATED APPLICATION

This application claims priority under 35 USC 119(e) to U.S. provisional Application Ser. No. 60/902,236, filed on Feb. 20, 2007, and which is incorporated herein by reference.

### TECHNICAL FIELD

The present invention relates generally to calendar applications and, more particularly, to systems, methods and apparatus for generating, accessing and retrieving schedule and calendar information via a data network.

### BACKGROUND

Electronic calendar applications and their functionality are well-known in the art. These calendar applications create a calendar entry for each event desired by the user to be placed in his/her calendar. To create a calendar entry, a user was traditionally required to manually input the relevant data for the entry. In 1998, the iCalendar format (iCalendar.ics) was introduced as a transfer method between calendar systems. The format has not had universal acceptance. Since implementation details are incumbent on the web designer for the calendar page, as practiced today, only a few systems take full advantage of this format, and most webpages which utilize the format only insert a single entry for Microsoft Outlook. Other, more elaborate systems using this format for transfer are dependent on the calendar application manufacturer's implementation of iCalendar and so do not have universal acceptance but are manufacturer specific.

Thereafter, calendar applications were interfaced with, or included within, email systems and enabled a user to create one (or a series of related) events or appointments for the user and others. The user's email system transmitted email messages containing the event(s) to the other desired participants, and after opening the email message, a window was displayed with links to allow the participant to either accept or reject the events(s). Upon selection of the “accept” link, the events were added to the participant's calendar. In this process, the schedule of events are “pushed” to the participant (or invitee or related user) by another user. One of the problems with this technology is that users/participants are generally required to use the same calendar applications and/or the same calendar data formats. Thus, users with different calendar applications usually cannot benefit from this feature. Moreover, these “events” are usually limited to appointments or meetings. In addition, such systems doe not allow a user to browse or view various or multiple and different schedules in diverse areas, such as sports schedules, musical events, school events, etc.

Accordingly, there are needed systems, methods and apparatus for identifying a schedule of interest and transferring schedule data representing the schedule of events from a remote location in response to a user request (e.g., a selection of a link).

### SUMMARY

In accordance with one embodiment, there is provided a method for retrieving schedule information from a remote location for use in an electronic calendar associated with a user device. The method includes transmitting a selectable link to a user device, receiving a user download request for a desired schedule in response to the user device selecting the link, retrieving schedule information corresponding to the desired schedule, the schedule information comprising a plurality of events, transferring the schedule information to the user device associated with an electronic calendar, enabling storage of a plurality of calendar entries associated with all or a subset of the plurality of events in the electronic calendar.

In accordance with another embodiment, there is provided a method of downloading schedule information from a remote location to a user device associated with a calendar application. The method includes receiving a request for a schedule, the request for the schedule initiated by a selection of a link within information transferred to the user device, retrieving schedule information corresponding to the schedule, the schedule information comprising a plurality of events, transferring the schedule information for use by the user device, and enabling storage of a plurality of calendar entries associated with all or a subset of the plurality of events in an electronic calendar associated with the calendar application.

In accordance with yet another embodiment, there is provided a fulfillment engine for downloading schedule information to a device for use in an electronic calendar of a user. The fulfillment engine includes a network interface coupled to a network operable for transmitting and receiving information via the network, memory for storing schedule information for a schedule of interest, and a processor coupled to the network interface. The processor is operable to: receive and process a request for schedule information, retrieve the schedule information, the schedule information comprising a plurality of events, and transfer the retrieved schedule information. The schedule information is operable for enabling the storage of a plurality of calendar entries associated with all or a subset of the plurality of events in an electronic calendar associated with a user.

In another embodiment, there is provided a method for retrieving schedule information from a remote location for use in an electronic calendar of a user. The method includes accessing a webpage hosted by a schedule host, selecting a link on the webpage, the link corresponding to a schedule of interest, and generating and transmitting a user request for the schedule of interest to a fulfillment server located at the remote location in response to the selection of the link. Schedule information is retrieved that corresponds to the schedule of interest, the schedule information comprising a plurality of events. The method further includes transmitting the schedule information to a user device executing a calendar application for maintaining an electronic calendar of the user, storing a plurality of calendar entries associated with the plurality of events in the electronic calendar.

Other technical features may be readily apparent to one skilled in the art from the following figures, descriptions, and claims.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 is an overall block diagram of a system for processing schedule data and transmitting the selected schedule data to a user device for generating a calendar (or calendar entries) for the user;

FIG. 2 is a more detailed block diagram of the user device shown in FIG. 1;

FIG. 3 is a more detailed block diagram of the fulfillment engine shown in FIG. 1;

FIG. 4 is an example display illustrating a schedule modifier prompt that may be generated and displayed to the user;

FIG. 5 is an example display illustrating a calendar entry.

FIG. 6 illustrates a method for requesting and downloading schedule data over the data network from a remote location and generating multiple calendar entries within a user's personal calendar;

FIG. 7 illustrates a method of a customer generating schedule data hosted by the fulfillment server 104; and

FIG. 8 illustrates a method of retrieving data from a user requesting schedule data.

### DETAILED DESCRIPTION

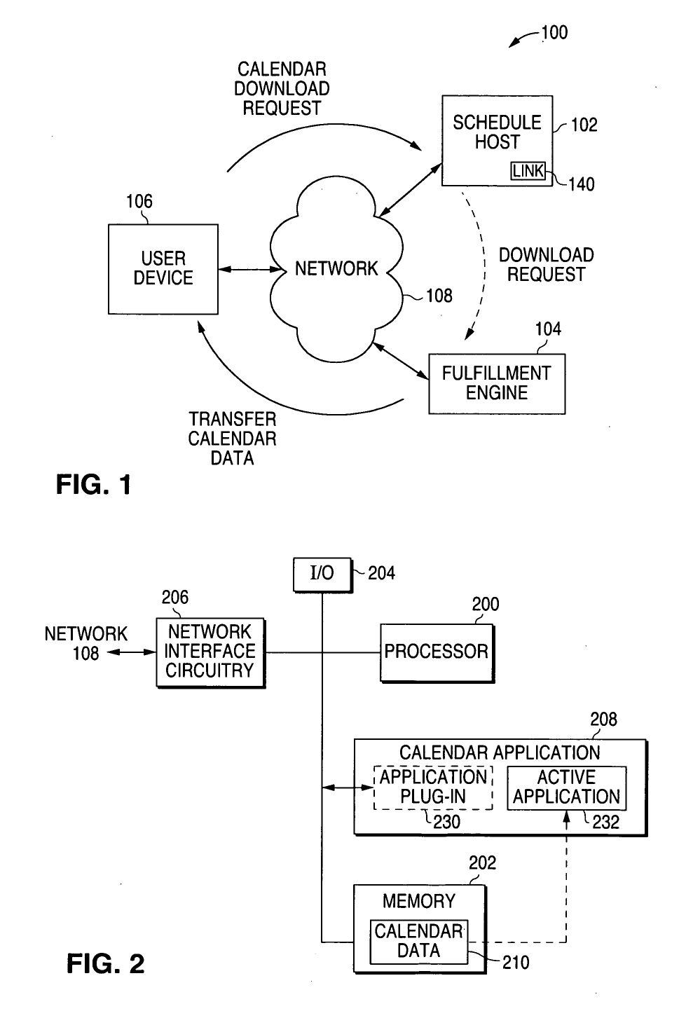

FIG. 1 illustrates one embodiment of a system 100, within an example data communications network, for retrieving and processing schedule information within a network and generating a calendar (or calendar entries) for a user. The system 100 includes a schedule or calendar host 102, a fulfillment engine (FE) 104, a user device 106 and a data network 108. As will be appreciated, these elements are communicatively coupled to each other via one or more communications networks or lines within the network 108. Though shown separate and physically remote in FIG. 1, the calendar host 102 and fulfillment engine 104 may physically reside together on the same device within another embodiment (not shown).

The system 100 shown in FIG. 1 is for illustration purposes only. Other embodiments of the system 100 may be used without departing from the scope of this disclosure.

Used herein, the terms “schedule” or “schedule data” shall refer to the general information or data (regardless of form) used to identify one or more events. In most cases, the schedule or schedule data corresponds to a plurality of events, however, only a single event may be included in a schedule. A “schedule entry” refers to a single event or entry (and its data) in a schedule. The term “calendar” refers to a given user's global or overall calendar (and information therein) composed of calendar entries. Each schedule generally relates to, or is organized in accordance with, one or more specified attributes (e.g., Notre Dame football schedule). The term “calendar entry” refers to a single event or entry (and its data) in a user's calendar, while “calendar data” refers to the underlying information defining the calendar entries. Schedule data may include additional information, referred to as modifier information, to enable the fulfillment engine 104 to filter the basic schedule data so that a user-designated subset of the schedule data can be transferred to “calendar entries” in the calendar for the user.

It will be understood that more than one user device 106 may be included within the system 100, and the user devices 106 represent devices that may be communicatively coupled to a data network, including but not limited to phones, computers, modems, PDAs, and other network devices and the like.

Now referring to FIG. 2, there is shown a general block diagram illustrating one embodiment of the user device 106. The user device 106 includes a processor 200, memory 202, input/output device(s) 204, interface circuitry 206, and a calendar application 208. The input/output devices 204 may include one or more of the following: a video display, audio speaker, microphone, mouse/trackball, keyboard, and any other devices operable for providing input/output functions for the user device 106. The user device 106 may be constructed or configured from any suitable hardware, software, firmware, or combination thereof for transmitting or receiving information over a data network, and for providing the functionality described herein.

The memory 202 includes calendar data 210. The calendar application 208 includes an active calendar application portion 232, and may optionally include (as part of or separate from the calendar application 208) a calendar application plug-in portion 230. The calendar application plug-in 230 provides an interface between the active portion 232 of the calendar application 208 and other device(s) communicating with the calendar application 208 (e.g., other devices on the network 108, such as fulfillment engine 104). Calendar application 208 may be a commercially available calendar application for maintaining and providing an electronic calendar and related functions, such as Microsoft Outlook or Lotus Notes, which processes the calendar data 220. Alternatively, the calendar application 208 may be a proprietary application or a modified version of commercially available calendar application program. In addition, the application 208 need not reside on the user device 106 and can alternately reside on the internet (at a server or other network device) via a personal calendar portal.

The calendar plug-in 230 communicates with the fulfillment engine 104 and provides an interface between the fulfillment engine 104 and the calendar application 208. The calendar plug-in 230 converts/processes schedule data generated by (and received from) the fulfillment engine 104 into a format readable by the calendar application 208. Alternatively, the fulfillment engine 104 communicates with the calendar application 208 and delivers the schedule data in a format recognizable by the calendar application 208. In such alternative configuration, the calendar application plug-in 230 is unnecessary.

Different embodiments (not shown) of the user device 106 are contemplated. In one embodiment, the user device 106 is a standalone programmable device. In another embodiment, the user device 106 is configured as two separate devices communicatively linked. When configured as two devices, one device 106a (e.g., computer, PDA, phone or other device) hosts and executes the calendar application 208 and accesses or retrieves the user's calendar data from/through another device 106b (e.g., computer, PDA, phone, general access server such as an exchange or web portal server). Additionally, the calendar application 208 may be hosted and executed by the other device 106b, and relevant data is transmitted to the first device 106a for display or other use. In any embodiment, the calendar application 208 (residing and executing on one of the devices) may optionally utilize the calendar plug-in 232, as described above.

It will be understood the user device 106 illustrated in FIG. 1 encompasses any of the herein described embodiments and configurations, and when the term “user device” or other term referring to the user device 106 is used herein, such term is meant to include these various embodiments and configurations (i.e., the user device 106 comprises a standalone programmable device or multiple devices 106a, 106b (not shown) operating collectively to provide a calendar application, capability or functionality to a user).

Now referring back to FIG. 1, the network 108 includes one or more local area networks (“LAN”), metropolitan area networks (“MAN”), wide area networks (“WAN”), all or portions of a global network such as the Internet, or any other communication system or systems at one or more locations, or combination of these, including wireless and wireline. Further, the network 108 may include various servers, routers, bridges, and other access and backbone devices. In one embodiment, the network 108 is a packet network that utilizes any suitable protocol or protocols, and in a specific embodiment, the network 108 (and most components connected thereto) operates in accordance with the Internet Protocol (“IP”) and/or the network 108 is the Internet. As will be appreciated, the concepts and teachings of the present invention may not be necessarily limited, but may be utilized in any data packet network that facilitates communication between components of the data network 108 (or within system 100), including IP packets, frame relay frames, Asynchronous Transfer Mode (“ATM”) cells, or other data packet protocols.

In the embodiment shown, the schedule host 102 is a network server, such as a conventional web server. The schedule host server 102 may be constructed or configured from any suitable hardware (processor, memory, input/output, interface circuitry, etc.), software, firmware, or combination thereof (not shown) for transmitting or receiving information over the network 108, and for providing the functionality described herein.

In one embodiment, the schedule host server 102 hosts a website and/or webpage accessed by the user device 106. Typically, a website/webpage will publish or display a schedule or calendar of events for a particular team, school, group, club, company, and organization, or even individual, (referred to as a “calendar host” or “entity”). For example, a college may have different organizations each having relevant schedules, such as major/minor sports, intramural sports, student clubs, alumni associations, parent associations, and music, theater and other performing departments, and class schedules. Elementary, middle and high schools may have similar structure. Companies may utilize schedules for company events, etc. The foregoing are only some examples of the schedule/calendar information that may be desired and accessed by the user device 106.

It will be understood that more than one schedule host 102 may be included within the system 100 (and more than one fulfillment engine 104 may be included). Each schedule host 102 provides one or more schedules or calendars of events, usually organized by one or more attributes. For example, a college (entity) may maintain one or more webpages on its website identifying any number of schedules/calendars, one each for each class or type of events (e.g., football, basketball, baseball, swimming, class schedules, etc.). Similarly, a professional sports team (entity) may maintain only one calendar for the team, but it could be broken down into subsets, such as home/away, day/night games. A particular entity is generally responsible for developing and maintaining its webpage.

In another embodiment, a particular webpage/website maintained by an approved entity may host any number of approved schedules for download. In yet another embodiment, multiple schedule hosts 102 may each host select schedules (e.g., one website/webpage may offer NCAA football team schedules while another website/webpage may offer Major League Baseball team schedules).

A calendar or schedule host (schedule host entity) generally creates or organizes events which have a specific date and/or time, and desires to distribute the schedule data to users. Schedule information may be distributed to end users through various mediums, including oral transfer, printed relay of the information (mail, hand-outs), web publishing, email (global or directed emails) and text or instant messages. Other methods may be used. The fulfillment engine 104 may receive schedule or calendar data from the schedule host. This may be done electronically from schedule host 102 (or devices associated therewith), or by other means or methods (as described above), including electronic file download/transfer (via the network 108 or from other storage mediums/transfers).

In the embodiment shown in FIG. 1, the schedule host server 102 publishes/displays or otherwise identifies a schedule via a webpage (e.g., the webpage references, associates, or identifies the schedule(s) of interest). A user (user device 106) navigates to the webpage displaying or identifying the desired schedule. The webpage further includes a selectable link 140 which, when selected by the user (user device 106) initiates downloading or transfer of the desired schedule data to the user device 106. The link 140 generally includes a coded message, such as a hyperlink or other similar link. Selection of the link 140 constitutes a request from the user device 106 to download the schedule of interest. The user request amounts to a request by the user to add the events in the schedule to the user's calendar. Other types of user requests from a user device 106 may be used.

The selectable link 140 includes a network destination address (e.g., IP address, domain name, etc.) and other identification information. This information includes an identifier identifying the calendar/schedule of interest and/or or a pointer to a file or executable application residing at the FFE 104 or another network device (or some other identifying information associated or capable of identifying such). In the embodiment illustrated in FIG. 1, the network destination address is the network destination address of the FFE 104.

It is possible that upon link selection, the host server 102 may download or otherwise transfer executable code or other script to the user device 106 for execution thereon. However, in the main embodiment described herein, user selection of the selectable link 140 does not cause direct downloading of any executable code or other script to the user device 106 (and no such code/script is downloaded in direct response thereto). In other words, link selection may be considered “passive” with respect to communications between the user device 106 and the host server 102—resulting in only a redirection request to the FFE server 104 without any further communications between the user device 106 and the host server 102 (relating to the schedule/calendar downloading).

Similarly, it is also possible that prior to selection of the link 140, when the user device 106 views or browses (i.e., downloads) the host server's 102 schedule/calendar webpage, the web page includes executable or other script (for operation on the user device 106) code which is downloaded (with or without user input) upon entering/visiting the webpage. In an embodiment described herein, no executable or other script code is necessary to be embedded within the webpage(s) hosted by the host server 102. As will be appreciated, the present disclosure advantageously eliminates reduces the need or requirement for extensive and/or complicated web page(S) (with the calendar information) that includes executable or other script code that needs downloaded from the host server 102 (or elsewhere) prior to presentment of the selectable link 140 and/or as a necessary operative step in the calendar download process.

Thus, in some embodiments, no executable or script related to the calendar/schedule is downloaded to the user device 106 from the host server 102 during visiting/viewing (other than download of the html for the full web page) or upon link selection. In this manner, the host server 102 (and its webpage(s)) operates independently of the fulfillment server 104.

In alternative embodiments, the selectable link 140 may be included within a text, email or webinar message or announcement received at the user device 106. Such messages may originate from the schedule host server 104, the fulfillment engine 102, or some other device (not shown). For example, the present disclosure provides for a simple and easy implementation when the selectable html link 140 is included in an email message (not shown). Use of an email message with an embedded link 140 functions efficiently within the system (host server 102, FFE 104) as described herein.

In the embodiment shown, the user request is “redirected” to the fulfillment engine 104 by clicking on the link 140, thus requesting the schedule data from the fulfillment server 104. The redirected request includes, generally at a minimum, information enabling the fulfillment engine 104 to identify the schedule of interest and the destination address of the user device 106. The fulfillment server 104 accesses the schedule data from storage, processes it, and transmits the schedule data to the user device 106 in a format compatible with its calendar application 208 or the calendar plug-in application 230. The calendar plug-in application 230 may also be downloaded to the user device 106, if necessary. Upon receipt of the schedule data, the calendar application 208 processes the data and generates corresponding calendar entries and stores these within memory 202, thus creating one or more calendar entries in the user's calendar in accordance with the schedule data.

In a different embodiment, the schedule host server 102 is responsible for obtaining or creating the schedule data and transferring the information to the fulfillment engine 104 for further processing and subsequent transmission to the user device 106 (as described above).

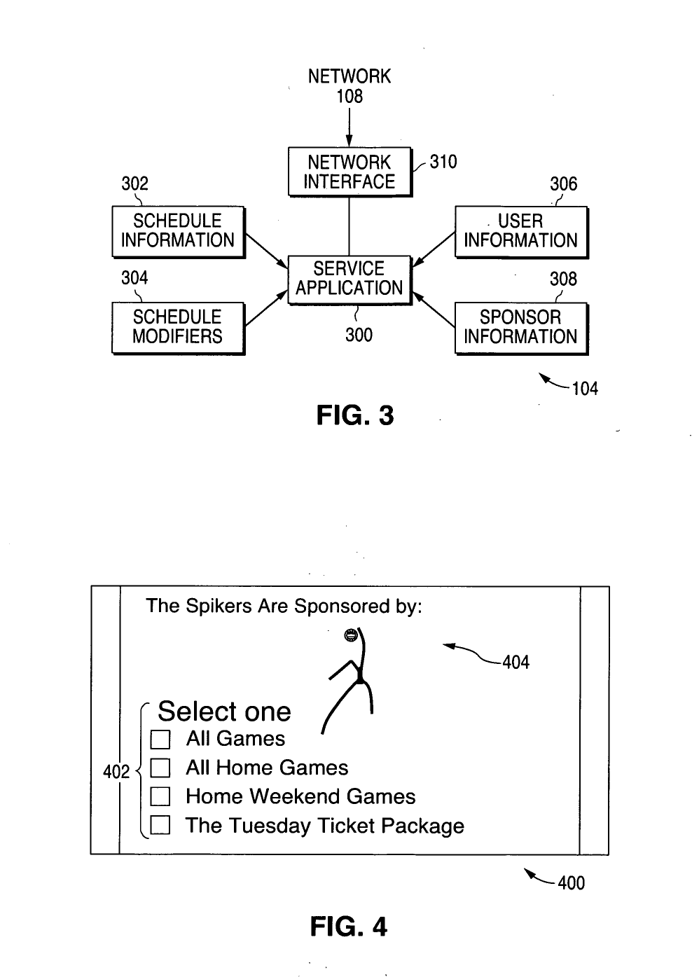

Now referring to FIG. 3, there is shown a general block diagram illustrating the fulfillment engine 104. The fulfillment engine 104 includes multiple components that enable seamless conveyance of schedule/calendar information to a user device 106. The fulfillment engine 104 generally includes a processor (not shown), internal and/or external memory for storing schedule information, and network interface circuitry 310 operable for executing a calendar service application 300 and communicating via the network 108, and for providing the functionality described herein. The fulfillment engine 104 may further include input/output devices and related functionality. The calendar service application 300 receives and processes schedule information 302, schedule modifiers 304, user information 306 and/or sponsor information 308 to generate and deliver schedule data to the calendar application 208 operating pursuant to the user device 106. The schedule information 302, schedule modifiers 304, user information 306 and sponsor information 308 are stored in memory, such as a database (not shown). The database may be internal or external to the fulfillment engine 104.

Schedule information (or data) 302 represents the underlying data describing one or more events (within a schedule/calendar) characterized by a specific date, time and/or other attribute. This information may be in a general (raw data) or specific format and is usually generated by the host or owner of the schedule.

Schedule modifier information (or data) 304 includes additional information relating to the schedule/calendar in question, such as information that allows or enables the fulfillment engine 102 to filter the schedule information and generate a predetermined set (or subset) of the overall calendar/schedule. One example, in the case of sporting events, would be calendar generation only for certain events, such as home or away events.

Sponsor information (or data) 306 represents information relating to a sponsor (or entity) for promotion or advertising purposes (i.e., sponsoring the schedule/calendar), such as the identity, field of interest, logos, etc. This information is assembled for promoting a sponsor to the user (via user device 106). Filtering or selection techniques may be used to select a sponsor and/or identify the predetermined sponsor information and incorporate or associate this information with the schedule data generated and transmitted by the fulfillment engine 104 to the user device 106. When a calendar event (or events) is accessed or displayed by the user device 106, the sponsor information may be displayed to the user.

Thus, the service application 300 examines sponsorship information related to the desired schedule. Depending on one or more factors, such as the type of calendar, advertising/sponsor relationships, and perhaps others factors, the fulfillment engine 104 may enter sponsorship data within the schedule data and/or display sponsorship data to the user in a variety of ways.

User information (or data) 308 represents information about the user and/or user device 106, and is used primarily to identify the user device 106, the calendar application 208, and to monitor what schedule information the user device 106 has accessed. The service application 300 obtains user information. This information enables the fulfillment engine 104 (through its service application 300 to deliver the schedule data to the user's calendar, and may include the primary calendar or calendar(s) for that user, locations and other necessary data to communicate the information.

Fulfillment engine 104 processes the information and generates schedule data in a format suitable for use by either the calendar plug-in 232 and/or calendar application 208 of the user device 106. Thus, the fulfillment engine 104 updates the user's calendar with the desired schedule (calendar information).

The fulfillment engine 104 transmits schedule data (or schedule-related data) to the user device 106 (in a format recognizable by the calendar application 208 or the calendar plug-in 232 when used) for calendar entry generation (or further manipulation or processing). The service application 300 may also select an appropriate delivery mechanism, such as through the data network 108 (via IP packets, email or text messages that may include attachments, etc.) to deliver the schedule data to the user device 106.

In one embodiment, schedule modifier information 304 may also be transmitted (included within or separate from the schedule data) enabling the user device 106 to select a subset or refinement of the full schedule (e.g., home/away games) for receipt and storage. The service application 300 applies modifier(s) to the schedule data. The user may be prompted for selection based on these modifiers. This allows the user flexibility in the amount and extent of information added to the user calendar. For example, after the user selects the link 140 (to initiate downloading of a calendar/schedule), the FFE 104 transfers data enabling the presentment of other selectable link(s) for selective downloading of subset(s) of the full calendar/schedule, as described in more detail below.

Referring to FIG. 4, there is shown an example display 400 (or prompt) including schedule modifier information (identified by reference numeral 402) that may be displayed by the user device 106. As shown, the user device 106 displays the schedule modifier information in this, or another format, and the user is therefore prompted to select all or a desired subset of the schedule data (all games, all home games, home weekend games, etc.). When selected, the selected schedule data is populated into the calendar application 108 (in response to communication of the selection to the fulfillment engine 104), as described herein.

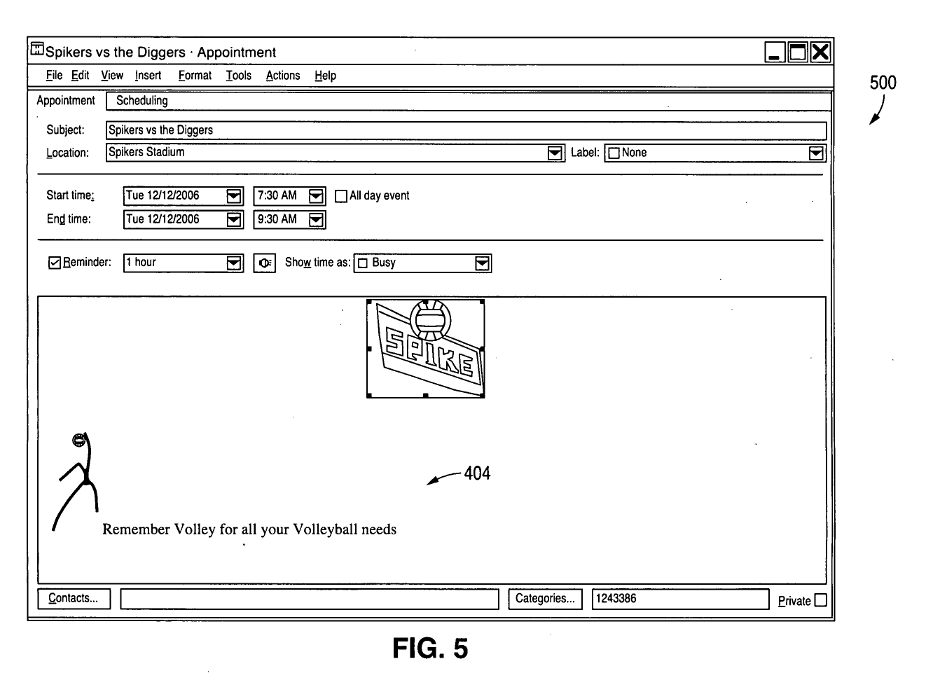

Referring still to FIG. 4, the display view 400 may optionally display sponsor information 404. Sponsor information represents information relating to a sponsor for promotion or advertising purposes (e.g., sponsoring the calendar/schedule). Sponsor information accompanies the downloaded schedule data and is generally incorporated into, or associated with, the calendar entries. When a calendar event(s) is accessed or displayed by the user device 106, the sponsor information may be displayed to the user. Referring to FIG. 5, there is shown an example calendar entry 500, as displayed by the user device 106. Various event and sponsor information is shown.

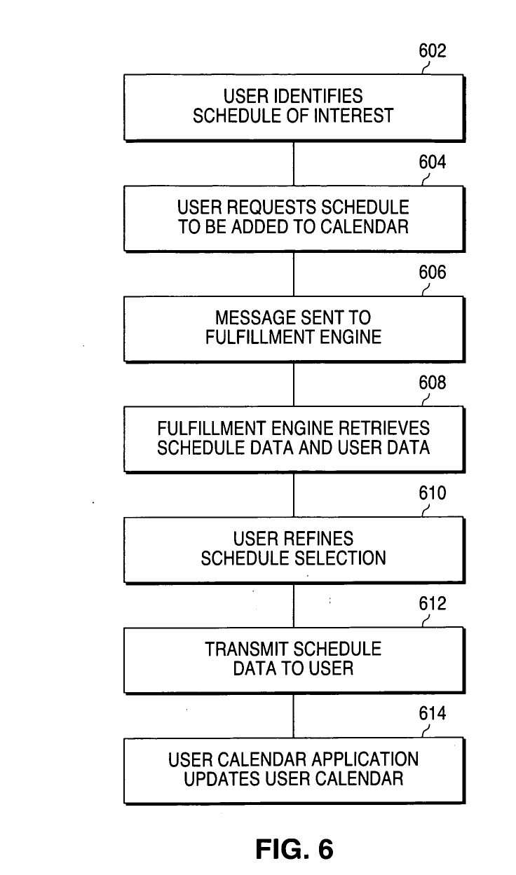

Now referring to FIG. 6, there is shown a method 600 of requesting and downloading schedule data over a data network from a remote location and generating multiple calendar entries within a user's personal calendar.

At a step 602, a user (through utilization of the user device 106) identifies a schedule of interest. This may be performed in one of several ways. In one application, the schedule host server 102 publishes a website/webpage which includes one or more given schedules for a particular organization, team, club, or type of event, etc. (as described previously). This may include a specific hosting entity only hosting those schedule(s) relating to, or affiliated with that hosting entity. In another manner, a hosting entity may publish a website/webpage identifying or hosting a selection of approved schedules. The user device 106 usually navigates/browses (explores) through the website/webpages(s) to identify the desired schedule. In another way, the user device 106 may receive a notification of one or more schedule event(s), via an email, text, webinar or other message. Such messages may originate as described previously above. This step may be accomplished in an automatic manner so that a device identifies the schedule of interest.

Once identified, at a step 604, the user requests the identified schedule to be added to their personal calendar. This is commonly done through a click (selection) on the link 140 included with the webpage(s) or message(s). There may be other methods by which a user requests an identified schedule be added. This step may be accomplished automatically without the need for user interaction.

The link 140 generally includes a coded message, or other information (as described previously), enabling the fulfillment engine 104 to recognize/identify the selected schedule (to be accessed). As known by those skilled in the art, selecting the link 140 generally causes the user device 106 to access a website/webpage identified in the link 140, or otherwise provide a command to the network device identified in the link 140. Other redirection techniques could be used, such as the schedule host server 102 directing (or redirecting) a message to the fulfillment engine 104 with the relevant information. As a result of the user request, at a step 606, a message (referred to as the user request message) is transmitted to the fulfillment engine 104. This message includes information sufficient to enable identification of the selected schedule, as well as some identification of the user device 106 (and/or user), such as the user device's network address.

As noted previously, the fulfillment engine 104 may execute or reside in a device remote from the schedule host 102, or it may execute or reside in a component within the schedule host 102. Normally, the fulfillment engine 104 will be hosted on another server within the network 108 to allow the handling of various schedules from different schedule hosts 102 (i.e., a clearinghouse or central portal) and is usually located remotely from the host server 102.

At a step 608, the fulfillment engine 104 retrieves the schedule information 302 associated with the identified schedule, and may also retrieve user information 306 about this user. If no data on this user (or user device) exists, or if additional information is desired, the fulfillment engine 104 may prompt the user to input user data. Alternatively, it may be programmed to accept defaults and not request or seek data about the user. In one embodiment, some or all of the user data 306 is received in response to a survey (received electronically via the data network 108 or other methods or means). A conventional “cookies” method may be used to associate the user to the user's data and/or provide a means to retrieve user data from the user device 106. The user data may include any relevant information about the user (and/or user's device 106), such as demographic data about the user, identity of the schedule(s) downloaded, and type of calendar application 108. Such information may be gathered and used for further purposes, such as directed marketing and advertising.

In the event the schedule data 302 is not previously stored at, or readily accessible by, the fulfillment engine 104, the fulfillment engine 104 may request this schedule data from the schedule host 102 (or an associated network device). In the alternative, the schedule host 102 may automatically transfer the schedule data along with the user request message, in response to the selection of the link 140.

In a step 610, the fulfillment engine 104 retrieves schedule modifier information 304, if any, related to the identified schedule. The fulfillment engine 102 processes the modifier information, which is then presented to the user device 106 in a format enabling the user to select a subset or refinement of the full schedule (see preceding description). In response to such selection or refinement, the desired schedule data is downloaded/transferred to the user device 106. Referring back to FIG. 4, there is shown one example of the display 400 that might be used. The schedule modifier information generally includes a tag or other identifier associated to each event or calendar entry within the overall calendar/schedule. Tags are customizable descriptors that allow each event or calendar entry to be categorized into one or more subsets identified with any suitable description (e.g., “HOME GAMES”, etc.).

In a step 612, the fulfillment engine 102 transmits the schedule data (the entire or refined schedule) to the user device 106 to be added to the user's calendar. The transmitted schedule information may be in various formats—in a format compatible with the calendar application 208 or the calendar plug-in 230 of the user device 106. Moreover, if a plug-in device is needed and not present within the user device 106, the fulfillment engine may optionally transmit the calendar plug-in 232 to the user device 106.

Once the schedule data is received, at a step 614, the calendar application 208 updates the user's calendar and stores the schedule information as calendar data 210 within the memory 202.

The method described above may further include additional or follow-on process for modifying or updating event(s) within a calendar/schedule previously downloaded from the FFE 104 to a user device 106. In addition, as described above with respect to the user device 106 logically comprising two separate devices (e.g., a remote PDA and a server), the schedule data and downloaded information from the FFE 104 may be transmitted to a calendar application that resides on an intermediate device, such as another server (not shown) which hosts the calendar application (e.g., Google calendar) and interfaces with the user device 106 which functions for calendar display, event notifications, etc. (functions like a thin client).

Upon a modification or change to one or more calendar entries, the FFE 104 or host server 102 generates an email message embedded with a selectable link (similar to the link 140) and transmits it to the user device 106 and identifying its subject matter in some fashion to alert the user. As will be appreciated, by virtue of the prior download transaction, the user or user device's email address or network address has been determined and stored in memory. The user clicks on the link and the updated schedule information is downloaded. The tags included in each calendar event facilitate updating of the entries and ensure that no entries are duplicated. This may be done by the transfer of only the affected calendar entry, or transfer of the complete schedule an with the calendar application 208 (and the plug-in) utilizing the tag information to ensure correct updating.

Alternatively, a user may periodically, or in response to receiving some alert indicating some portion of the calendar has changed (e.g., an alert on the calendar webpage of the host server 104, a conventional email message without a selectable link, etc.), visit the calendar web page of the host server 102 and re-download the desired calendar (i.e., repeat steps 604-612).

After a schedule has been downloaded and the communication session terminated, in another communication session (return to communication as described in the preceding paragraphs) the FFE 104 may cause a display to the user to include a “DELETE ALL” link. Clicking on this link will cause the FFE 104 to instruct the calendar 208 to delete the entire schedule. This is facilitated by the use of the ID markers and tags in each entry stored in the calendar. Alternatively, the calendar plug-in may include functionality to operate independently (without communication with the FFE 104 or host server 102) and prompt for user input in order to delete all events in a particular schedule, if desired.

It will be understood that the steps identified herein are not required to be performed in or limited to any specific order, and not each and every step may be required or necessary.

The fulfillment engine 104 advantageously allows for downloading of a desired schedule consisting of multiple events or calendar entries in response to a single selection (click) of the link 140. Filtering of schedule data may also be performed in order to download/updating only selected schedule information (e.g., a subset of the overall schedule data).

The system 100 also provides a mechanism to delete and/or modify information within a schedule that has been placed in the user's calendar. A unique code is added into each calendar entry that is generated in response to the downloaded schedule data, as illustrated in the FIG. 5, where there is a code in the category section of the calendar event 502. This code identifies those calendar entries associated with the desired schedule, and thus, enables deletion or modification of one or more of the entries within the group. The calendar plug-in 230 searches for the code and can modify the that particular schedule, such as adding, modifying, or deleting one or more of the calendar entries, in accordance with received instructions (e.g., the user requesting and receiving an updated schedule). This is important if there is a change to the schedule that needs to be updated to the user. In a specific embodiment in which the calendar application 208 is Microsoft Outlook, each calendar entry includes a unique key number added to the category field.

In general terms, in a first embodiment, a user device 106 accesses a webpage (hosted on a schedule host server 102) and wants to download certain calendar or schedule information published on the webpage. A single click on a link within the webpage selects a specific overall schedule or events or calendar entries corresponding thereto. The user device 106 is redirected to the fulfillment engine 104 which, after possibly examining one or more aspects about the user, loads calendar/schedule information corresponding to the selected link from its database and downloads the information to the user's calendar. During this process, if the calendar entries are associated with schedule modifier information (subset information), the various subsets are presented for selection to the user and the user may select one or all for download. A calendar plug-in reads the information and interfaces with the calendar application thereby inserting the calendar entries into the user's calendar. The calendar application and/or calendar may reside on the user device or a server associated with the user device. Information (e.g., ID markers, tags, flags) or code is placed or embedded within, or otherwise associated with, each of the calendar entries to uniquely identify the calendar entries associated with that specific calendar/schedule. This enables the multiple added entries to be ascertained/identified and deleted or modified (at a later date). This also prevents the duplication or double entry of calendar entries if the schedule or calendar entries are downloaded more than one time.

In another embodiment, instead of utilizing a webpage allowing the user to identify the schedule of interest (and click on the link), an email or other notification medium is used. The user clicks on a link within the email or other notification, and the fulfillment engine 104 proceed, as identified herein.

In yet another embodiment, the schedule information stored in the database of the fulfillment engine 104 is optionally transferred from the schedule host 102 (or other networked device) to the fulfillment engine 104 in response to the user request (selection of the link).

Optionally, the calendar plug-in may be replaced with another device, as required or necessary by the user device calendar program

The disclosed embodiments describe a “pull” technology in which the user pulls (solicits or requests) the desired schedule information from a source. One advantage herein is that the user or user device 106 is not required to “register” with the schedule resources. The fulfillment server 104 provides a diverse platform. In one embodiment, the entity which maintains the schedule (referred to as a customer) can publish this schedule on their own server in their own format, and the webpage is independent (not under control) of the fulfillment server 104. The schedule host or other customer is free to create a schedule on their website in their best display mode without having to conform to any particular format or be in any particular location. This allows easier development on the part of the customer as well as not having to repeat development between showing their schedule to subscribers and non-subscribers. When there is user interest for a given schedule, in one embodiment, the link 240 on the website/webpage of the calendar host 102 directs the fulfillment server 104 to deliver the content.

The present disclosure provides the ability to transfer easily multiple schedule entries from the host to the user without the need for the user to confirm every single event/entry. The programming task of updating/transferring the requested schedule and updating user calendars can be offloaded from the schedule host (e.g., schedule host 102) to an independent server (and users, more particularly information about users, may be optionally tracked). Very few websites (and website programmers), if any, have the capability to render the website with the functionality to check identify which calendar application a user device is implementing. In contrast, one embodiment described herein does not require any special programming of the schedule host website—data formatting accomplished in fulfillment engine 104 and schedule/calendar entry assisted with calendar application plug-in.

Various other advantages are provided by disclosed methods and system. The system can be expanded with a large number of customer servers (e.g., schedule host servers 102). The control and format for the customer schedule can remain with the customer on the customer server simplifying integration from the customer's perspective and from the operator of the fulfillment server 104. The architecture easily allows these servers to represent a multitude of operating systems and a multitude of applications.

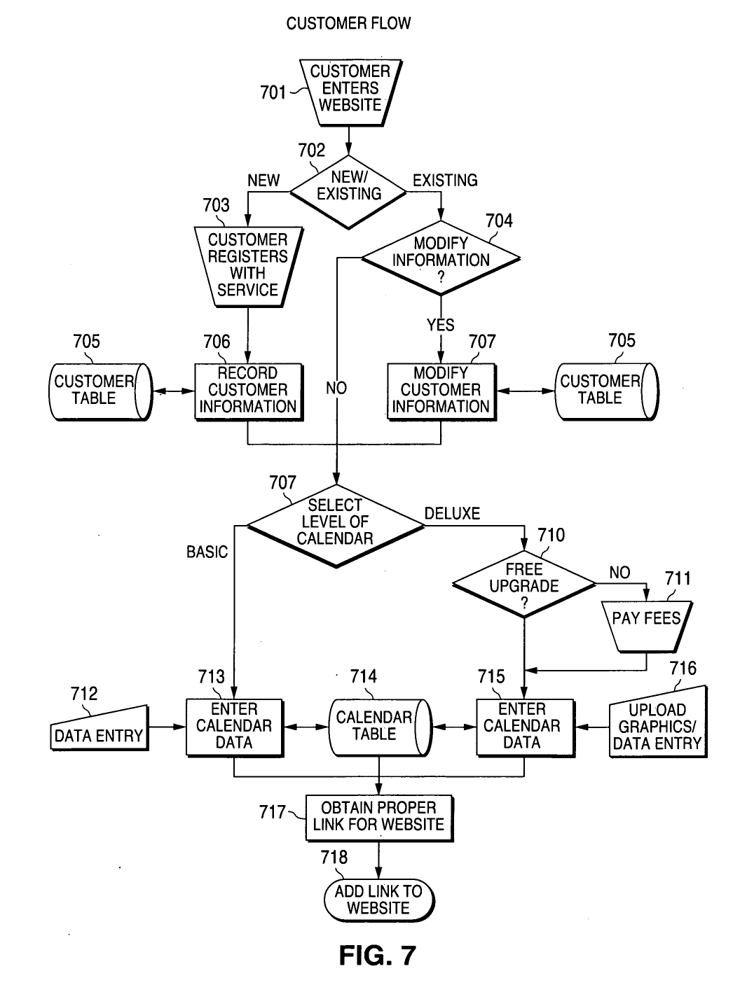

Now referring to FIG. 7, there is shown a method of a customer or user (referred hereinafter as a “customer”) generating schedule data hosted by the fulfillment server 104. When the customer enters the website (step 701), the customer must be registered in order to enter a schedule into the system. The customer is asked whether they are a new or existing customer (step 702), and the customer supplies this information.

If an existing customer, the customer is asked whether they wish to change their customer information (step 704). If so, the customer modifies their existing customer information (step 707) which is stored in the customer table (identified by reference numeral 705). If a new customer, the new customer registers with the service (step 703) and records their customer information (step 706) into the customer table 705.

The customer selects the level of calendar (step 707) desired to be hosted (or is currently hosted) by the fulfillment server 104. If a basic calendar, the customer enters the basic calendar information and schedule data (step 713) and this information and data is stored into the calendar table (identified by reference numeral 714). If a “deluxe” calendar, it is determined whether the customer qualifies for a free calendar upgrade (step 710). If payment is necessary to qualify the customer for deluxe calendar, the customer makes payment (step 711). Thereafter, the customer enters the deluxe calendar information and schedule data (step 715) and this information and data is stored into the calendar table 714. It will be understood that what constitutes a “basic” and “deluxe” calendar may be based on various factors, as determined or desired. In one example, a deluxe calendar includes the capability of loading or including additional or special graphical data (step 716) when the calendar data or schedule information is entered at step 715. During this process, the customer may tag certain events with a descriptor. The FFE 104 processes this information which allows the user device 106 to download only a subset of the full calendar, instead of requiring download of the entire schedule (thereby eliminating the manual deleting of the events they do not want in their calendar).

Thereafter, at the conclusion of entering the data (steps 713, 715), the customer is provided with a link or link information (step 717) that the customer places on the customer's website or is used for other purposes (consistent with, or as taught) herein. If used in conjunction with the customer's website, the link is placed on, or incorporated into, the website (step 718).

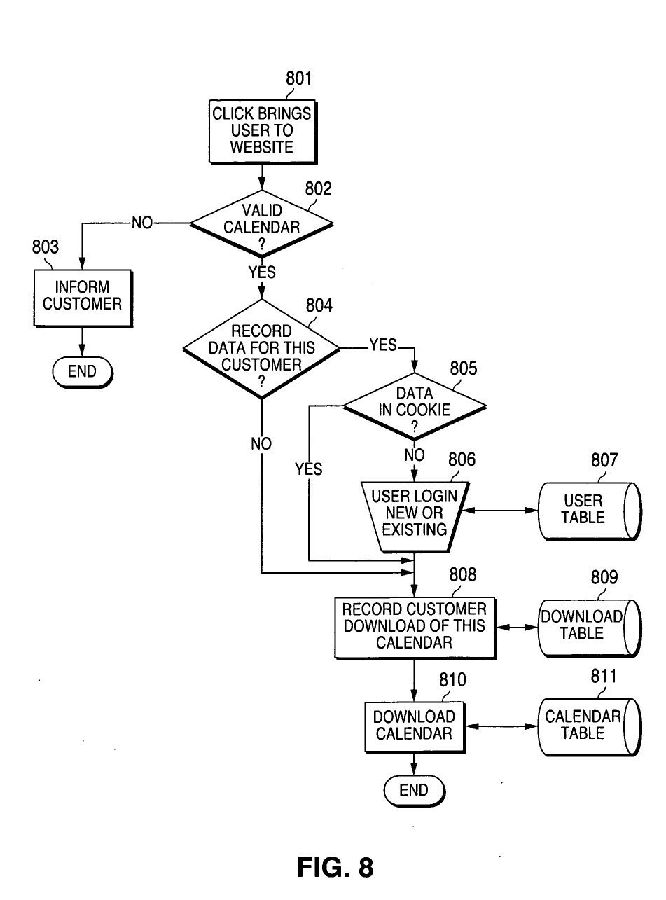

Now referring to FIG. 8, there is shown a method of retrieving schedule data for a user after the user activates the link which has been on the customer website. In this example, a user accesses and clicks an icon on the customer's website (step 801) and is directed to the fulfillment engine 104. The information is first checked to determine whether there is a valid schedule for that entry (step 802). If there is no valid schedule, the user is informed (step 803) and the process is completed. If there is a valid schedule, the fulfillment engine 104 determines whether to record data for this customer (step 804). If data is not to be recorded, the fulfillment engine 014 proceeds to download/transfer the schedule data to the user (step 809). If the fulfillment engine 104 is to record customer data, it verifies the information for that user. The fulfillment engine 104 may check to determine whether this user is a previous user by searching for existence of a known cookie on the user device (step 805). If no cookie exists, the user is prompted to log in (step 806) and the user identification is verified using information stored in the user table (identified by reference numeral 807). If a new user, a new user account is established and the user information is recorded in the user table 807. After a user is verified, the download/transfer instance is recorded (step 808) in the download table (identified by reference numeral 809) either before or after actual download/transfer (step 810) of the schedule data (obtained from the calendar data table 811).

In general operation (and in one embodiment), a user (user device) visits an organization's website where they see a link (or button) indicating the user can click the link to download the organization's schedule. Upon selection of the link, the user is redirected to a fulfillment engine (FFE) server located remotely and operating independently of the organization website. This communication to the FFE server initiates execution of the service application residing on the FFE server. The service application may have a complementary application (the calendar plug-in) executing on the user device. The calendar plug-in may be downloaded and initiated upon link selection (and/or with user input) or simply initiated upon link selection if previously downloaded. Alternatively, no calendar plug-in may be needed, and service application executing on the FFE server includes all the necessary functionality to interface with the user device calendar application and download data directly thereto. When the service application (and/or the calendar plug-in) executes, the user is prompted to select the events they wish to download. These events may be categorized as “all” events”, a subset of events or events with certain attributes, or individual events selected from a list. When they have made their selection and have clicked a displayed “download” button, the user's calendar application is populated, the user is notified that the population was successful, and the service application (and/or the calendar plug-in application) may thereafter close.

In the event the user desires to update their schedule/calendar to get the latest update, or to download a different set of events from the same calendar (or delete multiple events previously downloaded), the user may initiate launching of the service application by clicking on a link which may be located in each/one of the event's information fields. Because each event within the calendar includes a unique tag, any updates to existing event information will be updated without adding replica events to the user's calendar.

In some embodiments, certain functions' and methods performed by the one or more of the devices/elements in system 100 are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or-any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. In this document, the term “couple,” “connect” and their derivatives refer to any direct or indirect communication between two or more elements, whether or not those elements are in physical contact with one another.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for retrieving schedule information from a remote location for use in an electronic calendar associated with a user device, the method comprising:
transmitting a selectable link to a user device;
receiving a user download request for a desired schedule in response to the user device selecting the link;
retrieving schedule information corresponding to the desired schedule, the schedule information comprising a plurality of events;
transferring the schedule information to the user device associated with an electronic calendar; and
enabling storage of a plurality of calendar entries associated with all or a subset of the plurality of events in the electronic calendar.

2. The method in accordance with claim 1 further comprising:
transferring a calendar plug-in application to the user device, the calendar plug-in application providing an interface between the transferred schedule information and the electronic calendar.

3. The method in accordance with claim 1 wherein the selectable link is included within a webpage transmitted to the user device from a schedule host server.

4. The method in accordance with claim 1 wherein the selectable link is embedded within an email message.

5. The method in accordance with claim 3 wherein the user download request is received at a fulfillment server located remotely from the schedule host server.

6. The method in accordance with claim 1 further comprising:
processing the retrieved schedule information and identifying at least one predetermined subset of the plurality of calendar events;
transmitting to the user device at least one subset selectable link identifying the at least one predetermined subset; and
transferring the schedule information associated with the selected subset to the user device in response to the user device selecting the subset link.

7. The method in accordance with claim 6 wherein a plurality of calendar events of the desired schedule are tagged to identify one or more subsets.

8. The method in accordance with claim 1 further comprising:
coding each of the plurality of calendar events within the transferred schedule information to enable modification of one or more of the calendar events.

9. The method in accordance with claim 1 further comprising:
transferring an update for the downloaded desired schedule to the user device in response to the user device selecting another link.

10. A method of downloading schedule information from a remote location to a user device associated with a calendar application, the method comprising:
receiving a request for a schedule, the request for the schedule initiated by a selection of a link within information transferred to the user device;
retrieving schedule information corresponding to the schedule, the schedule information comprising a plurality of events;
transferring the schedule information for use by the user device;
enabling storage of a plurality of calendar entries associated with all or a subset of the plurality of events in an electronic calendar associated with the calendar application.

11. The method in accordance with claim 10 wherein the calendar application is located within the user device.

12. The method in accordance with claim 10 wherein an event comprises a plurality of calendar entries and wherein each entry may be separately stored.

13. The method in accordance with claim 10 wherein the link is embedded in an email message.

14. The method in accordance with claim 10 wherein the link is included in a webpage accessed by the user device.

15. A fulfillment engine for downloading schedule information to a device for use in an electronic calendar of a user, the fulfillment engine comprising:
a network interface coupled to a network operable for transmitting and receiving information via the network;
memory for storing schedule information for a schedule of interest;
a processor coupled to the network interface, the processor operable to:
receive and process a request for schedule information,
retrieve the schedule information, the schedule information comprising a plurality of events,
transfer the retrieved schedule information, and
wherein the schedule information is operable for enabling the storage of a plurality of calendar entries associated with all or a subset of the plurality of events in an electronic calendar associated with a user.

16. The fulfillment engine in accordance with claim 15 wherein the request is initiated by selection of a link that corresponds to a schedule of interest.

17. The fulfillment engine in accordance with claim 16 wherein the link is on a webpage hosted at a remote location.

18. The fulfillment engine in accordance with claim 16 wherein the schedule information corresponds to a schedule of interest and wherein at least one of the plurality of events is associated with a subset identifier operable for identifying the at least one of the plurality of events as a member of a subset group of events within the schedule of interest.

19. A method for retrieving schedule information from a remote location for use in an electronic calendar of a user, the method comprising:
accessing a webpage hosted by a schedule host;
selecting a link on the webpage, the link corresponding to a schedule of interest;
generating and transmitting a user request for the schedule of interest to a fulfillment server located at the remote location in response to the selection of the link;
retrieving schedule information corresponding to the schedule of interest, the schedule information comprising a plurality of events;
transmitting the schedule information to a user device executing a calendar application for maintaining an electronic calendar of the user; and
storing a plurality of calendar entries associated with the plurality of events in the electronic calendar.

20. The method in accordance with claim 19 further comprising:
downloading a calendar plug-in application to the user device, the calendar plug-in application providing an interface between the transmitted schedule information and the calendar application.

21. The method in accordance with claim 19 wherein the calendar host and the fulfillment server are maintained separately.

22. The method in accordance with claim 19 wherein the calendar host and the fulfillment server are maintained together.

23. The method in accordance with claim 19 wherein the schedule information corresponds to a schedule of interest and wherein at least one of the plurality of events is associated with a subset identifier operable for identifying the at least one of the plurality of events as a member of a subset group of events within the schedule of interest.

24. The method in accordance with claim 19 further comprising:
processing the retrieved schedule information and identifying at least one predetermined subset of the plurality of events;
transmitting to the user device at least one subset selectable link identifying the at least one predetermined subset; and
transferring the schedule information associated with the selected subset to the user device in response to the user device selecting the subset link.
